(19) United States
(12) Patent Application Publication
(10) Pub. No.: US 2025/0260892 A1
(43) Pub. Date: Aug. 14, 2025

(54) AGGREGATING CAPTURE SPECIFICATIONS FOR MEDIA CONTENT USING GENERATIVE ARTIFICIAL INTELLIGENCE

(71) Applicant: Motorola Mobility LLC, Chicago, IL (US)

(72) Inventors: Amit Kumar Agrawal, Bangalore (IN); Rahul Bharat Desai, Hoffman Estates, IL (US)

(73) Assignee: Motorola Mobility LLC, Chicago, IL (US)

(21) Appl. No.: 18/438,373

(22) Filed: Feb. 9, 2024

(51) Int. Cl. H04N 23/60

(52) U.S. Cl. CPC H04N 23/64

(57) ABSTRACT

In aspects of aggregating capture specifications for media content using generative artificial intelligence (AI), a client device can aggregate one or more capture specifications for capturing media content based on inputting one or more media specifications of an application to a generative AI. The client device can cause an instance of the media content to be captured by one or more media capture devices based on applying the one or more capture specifications. The client device can provide the instance of the media content to the application.

### BACKGROUND

Devices, such as smart devices, mobile devices (e.g., cellular phones, tablet devices, smartphones), consumer electronics, and the like, can be implemented for use in a wide range of environments and for a variety of different applications. In some examples, the devices provide for input of an instance of a media content. The media content may be an example of image or photo content, video content, and/or audio content. A user can provide one or more instances of media content to an application implemented at the device. In variations, the device may include and/or may be in communication with one or more media capture devices to capture the instances of media content. The media capture devices can include, but are not limited to, cameras and/or audio capture components (e.g., microphones).

### BRIEF DESCRIPTION OF THE DRAWINGS

Implementations of the techniques for aggregating capture specifications for media content using generative artificial intelligence (AI) are described with reference to the following Figures. The same numbers may be used throughout to reference like features and components shown in the Figures:

FIG. 1 illustrates an example system for aggregating capture specifications for media content using generative AI in accordance with one or more implementations as described herein.

FIG. 2 illustrates an example process flow, which supports aggregating capture specifications for media content using generative AI in accordance with one or more implementations as described herein.

FIGS. 3 and 4 further illustrate example systems for aggregating capture specifications for media content using generative AI in accordance with one or more implementations as described herein.

FIG. 5 further illustrates an example processing diagram for aggregating capture specifications for media content using generative AI in accordance with one or more implementations as described herein.

FIG. 6 further illustrates an example block diagram for aggregating capture specifications for media content using generative AI in accordance with one or more implementations as described herein.

FIG. 7 illustrates an example method for aggregating capture specifications for media content using generative AI in accordance with one or more implementations of the techniques described herein.

FIG. 8 illustrates various components of an example device that can be used to implement the techniques for aggregating capture specifications for media content using generative AI as described herein.

### DETAILED DESCRIPTION

Implementations of techniques for aggregating capture specifications for media content using generative AI are described herein. In some examples, a device can implement an application and/or one or more services that provide for upload and/or capture of media content. The device may trigger initialization of one or more media capture devices to capture an instance of the media content. The instance of media content can be used for identification, reporting, or content creation, among other use cases for respective services and/or applications. In some cases, an instance of the media content may have one or more specifications for a defined use case. The specifications may include, but are not limited to, physical dimensions of the media content, a capture device used to capture the media content, a file size of the media content, color of the media content, a placement of objects included in the media content, a volume of the media content, or a file format of the media content. For example, if the instance of the media content is an image of a user for an identification service, then the specifications may include a set of conditions for the image (e.g., user not wearing a hat or glasses, no background in the image, head of the user within a threshold distance from the edges of the image, etc.). Different applications and/or services may have different specifications for media content captured for the applications and/or services.

In some examples, a user may be unaware of the specifications for the media content when capturing the media content using the device. For example, the user may provide input to the device triggering initialization of media capture devices for capturing an instance of media content for an application and/or service. The user may provide additional input to the device triggering the capture of the instance of the media content using the media capture devices. The resulting instance of the media content may not satisfy the specifications, because the user may not be aware of the specifications. Thus, the device receives input that indicates to discard the instance of the media content and that triggers capture of an additional instance of the media content to satisfy the specifications, causing increased processing and memory usage at the device related to capture of the additional instance of the media content, as well as high signaling overhead due to communications between the device and the media capture devices. Additionally, or alternatively, the device can implement post processing techniques to provide for modification of the instance of the media content to satisfy the specifications, causing increased usage of processing and memory resources.

As described herein, to reduce usage of processing and memory resources related to an instance of media content failing to satisfy specifications, a device can aggregate capture specifications for media content by inputting media specifications for the media content into generative AI. The device may determine that an application and/or a service is configured to receive input of media content via one or more media capture devices (e.g., a front and/or a rear camera of the device). The device may identify one or more media specifications of the application and/or the service for the media content prior to capturing an instance of the media content. The device may identify the media specifications by analyzing context of the media content and/or by obtaining information including the media specifications (e.g., from a body of text provided by the application and/or user input). The device may input the media specifications to generative AI trained to aggregate capture specifications using the media specifications. The device may initiate a media content capture process by launching at least one media capture device according to the capture specifications (e.g., front camera to capture an image of a face of a user, rear camera to capture an image of a receipt, macro camera to capture an image of a barcode or other image that is within a threshold distance from the device, etc.). In some examples, the device can output prompts for display via a user interface that provide user guidance for satisfying the capture specifications. Once at least a portion of the capture specifications are satisfied, then the device can cause an instance of the media content to be captured by a media capture device. Once the capture is complete, the device can perform additional processing on the instance of the media content to ensure the instance of the media content satisfies any remaining capture specifications (e.g., replace a background portion of an image with a color defined by the capture specifications).

In some examples, using capture specifications output from generative AI may provide for reduced usage of computational resources (e.g., processing resources, memory resources, communication resources etc.). For example, a device may receive the capture specifications as output from the generative AI and may perform a media capture process using the capture specifications to ensure an instance of media content captured during the media capture process satisfies the capture specifications (e.g., by implementing the capture specifications and/or by generating prompts to output for display that provide user guidance regarding the capture specifications). Thus, an instance of the media content that satisfies the capture specifications is automatically obtained (e.g., captured and/or identified) without manual interactions to modify media content, including post processing and/or capturing another instance of the media content to satisfy the capture specifications.

While features and concepts of the described techniques for aggregating capture specifications for media content using generative AI can be implemented in any number of different devices, systems, environments, and/or configurations, implementations of the techniques for aggregating capture specifications for media content using generative AI are described in the context of the following example devices, user interfaces, systems, and methods.

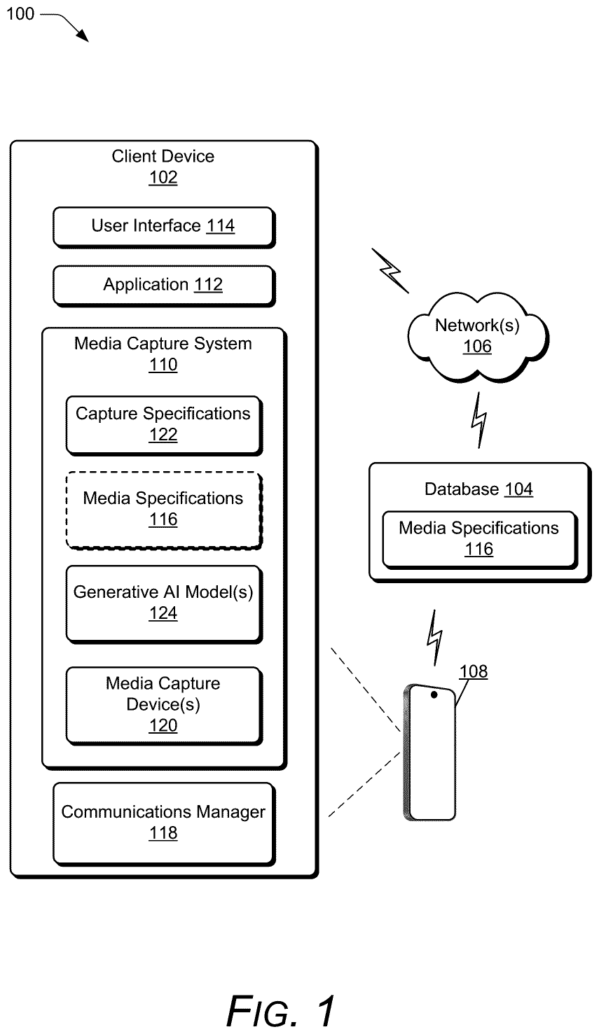

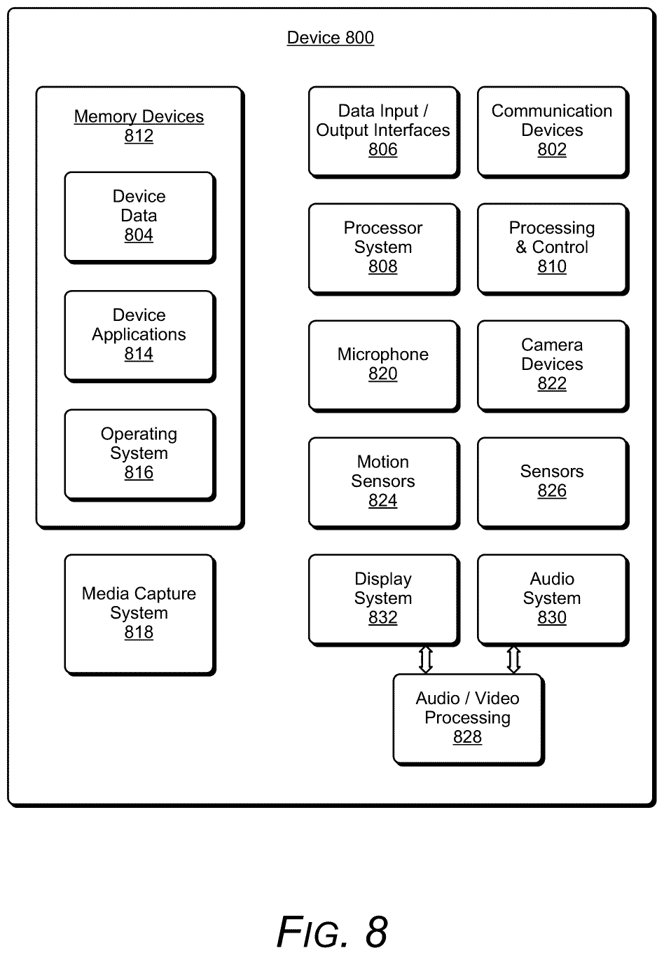

FIG. 1 illustrates an example system 100 for aggregating capture specifications for media content using generative AI, as described herein. The example system 100 includes a client device 102 and a database 104, where the client device 102 and the database 104 are interconnectable via one or more networks 106. In some examples, the client device 102 include a server device, a smartphone, a mobile phone, and/or any other type of wireless device or mobile device 108. The client device 102 can be implemented with various components, such as a processor system and memory, as well as any number and combination of different components as further described with reference to the example device shown in FIG. 8. In implementations, the client device 102 includes various radios for wireless communication with other devices (e.g., via the networks 106). For example, the client device 102 may include a Bluetooth (BT) and/or Bluetooth Low Energy (BLE) transceiver and/or a near field communication (NFC) transceiver. The client device 102 can also include a Wi-Fi radio, a global positioning system (GPS) radio, and/or any type of device communication interfaces.

In some examples, a client device 102 may implement a media capture system 110 for capturing one or more instances of media content. The media content may include one or more of image content, video content, audio content, and/or any other digital content. In some cases, at least a portion of the media capture system 110 is implemented by an application 112 of the client device 102 and/or using various resources of the client device 102, such as hardware resources, an operating system, firmware, and so forth. Alternatively, or additionally, the media capture system 110 is implemented by server-based storage resources, processing resources, and so on of devices other than the client device 102. For example, at least a portion of the media capture system 110 can be implemented using a third-party service, such as a web services platform that provides one or more hardware and/or other computing resources to support provision of services by web service providers. In variations, an entirety, or various portions of the media capture system 110 are implemented at or by the client device 102 of a user (e.g., a mobile device, a laptop, a wearable device, or any other device).

A client device 102 may be configurable in a variety of ways. A client device 102, for instance, is configurable as a desktop computer, a laptop computer, a mobile device 108 (e.g., assuming a handheld configuration such as a tablet or mobile phone), an IoT device, a wearable device (e.g., a smart watch, a ring, or smart glasses), an augmented reality and/or virtual reality device (e.g., the smart glasses), a server, and so forth. Thus, a client device 102 ranges from full resource devices with substantial memory and processor resources to low-resource devices with limited memory and/or processing resources. Although in instances in the following discussion reference is made to a client device 102 in the singular, a client device 102 may also be representative of multiple different devices.

The application 112 causes various systems of the client device 102 to output a user interface 114 of the application 112, such as by displaying a user interface 114 via a display device (e.g., a graphical user interface (GUI)) or making accessible voice-based user interfaces. Through interaction of a user with the client device 102, the application 112 receives user input via one or more user interfaces 114. Examples of such input include, but are not limited to, receiving touch input in relation to portions of a displayed user interface, receiving one or more voice commands or other audio input, receiving typed input (e.g., via a physical or virtual (“soft”) keyboard), receiving mouse or stylus input, and so forth. One example of the application 112 is a browser, which is operable to navigate to a website, display pages of the website, and facilitate user interaction with web pages of the website. Another example of the application 112 is a web-based computer application, such as a mobile application or a desktop application. The application 112 may be configured in different ways, which enable users to interact with their client devices 102 and by extension perform actions, without departing from the spirit or scope of the techniques described herein.

In at least one implementation, the application 112 supports communication of data across the network(s) 106 between the client device 102 and the database 104. The database 104 may represent one or more databases and/or other types of storage capable of storing media specifications 114. Examples of the database 104 include, but are not limited to, mass storage and virtual storage. In one or more implementations, for example, the database 104 may be virtualized across multiple data centers and/or cloud-based storage devices. In some other examples, the database 104 may be a local database hosted by the client device 102. The database 104 may store media specifications 114 for media content. Example media specifications include, but are not limited to, an object to be captured by the media content, physical dimensions of the media content, a capture device used to capture the media content, a file size of the media content, color of the media content, a placement of objects included in the media content, a volume of the media content, or a file format of the media content.

In some examples, the client device 102 may parse one or more data sources to obtain the media specifications 116. The client device 102 may access one or more of public data storage, application data for the application 112, and/or may use processing techniques to determine context of prior media content to obtain the data sources. Determining the context of prior media content can include using object recognition and/or feature extraction techniques, such as when the media content includes images and/or videos. If the data sources include text data, the parsing can include detecting string and/or character values that indicate the media specifications 116. In some other examples, the client device 102 may receive an indication of the media specifications 116 (e.g., via the user interface 114). In some cases, the client device 102 may transmit the media specifications 116 to the database 104 for storage (e.g., via the networks 106).

The client device 102 can include a communications manager 118 for accessing the database 104 to store the media specifications 116 and/or to obtain the media specifications 116. The communications manager 118 represents functionality (e.g., logic and hardware) for enabling the client device 102 to interconnect with other devices and/or networks, such as the networks 106. The communications manager 118, for instance, enables wireless and/or wired connectivity of the client device 102. For example, the communications manager 118 represents one or more antennas for transmitting and receiving signaling from other devices and/or the database 104 via the networks 106. The networks 106 can include computer networks and/or telecommunication networks. For example, the networks 106 include a wireless local area network (WLAN), a wireless network, a BT network, a cellular network, a satellite network, and/or a fiber optic network. The networks 106 connect one or more devices, such as the client device 102 and the database 104, among others.

In some examples, the media capture system 110 may include, or may be in communication with, one or more media capture devices 120. In variations, the media capture devices 120 are physically coupled to the client device 102 (e.g., located within a housing of the client device 102). In some other variations, the media capture devices 120 are remote to the client device 102 and are in communication with the client device 102 via a wireless connection (e.g., Wi-Fi, Bluetooth, or other network connection) and/or a wired connection (e.g., a bus or other physical forms of connection). Example media capture devices 120 include, but are not limited to, cameras, microphones, and/or other devices for capturing media content. For example, the media capture devices 120 may include a camera and/or microphone positioned on a side of the client device 102 that includes a display component, which may be referred to as the front of the client device 102. The display component outputs a user interface 114 for display and can include a screen or other component. In some other examples, the media capture devices 120 can include a camera and/or microphone positioned on a side of the client device 102 opposite to the display, which may be referred to as the back of the client device 102.

Additionally, or alternatively, the media capture devices 120 may include a media capture device 120 (e.g., a camera and/or microphone) with different capabilities, such as a focus and/or range capability. For example, the media capture devices 120 may include a media capture device 120 for capturing media content within a threshold distance from the media capture device 120 (e.g., referred to as a macro camera if the media capture device 120 is a camera) and/or another media capture device 120 for capturing media content outside of the threshold distance from the media capture device 120. The media capture devices 120 may include any numerical quantity of media capture devices 120, including media capture devices 120 positioned relative to the client device 102 and/or for capturing media content at any range or distance relative to the client device 102.

In some examples, the client device 102 may receive input from a user via one or more interactable elements at the user interface 114 displaying the application 112. The input may include an indication to initiate a media capture process to capture an instance of media content. The instance of the media content may have one or more capture specifications 122, which may include the media specifications, as well as one or more instructions for initializing the media capture devices 120. For example, if the application 112 is an application for submitting an image of a user to obtain an identification document, then example media specifications include, but are not limited to, the image including a face of a user, one or more objects being absent from the image (e.g., glasses, hats, scarfs, etc.), a color or pattern of a background portion of the image, physical dimensions defining a size of the image, a file type of the image, or a physical dimensions defining a size of the face relative to the size of the image. If the image is of a face of the user, then the instructions for initializing the media capture devices 120 may include to initialize a media capture device 120 at the front of the client device 102 and adjusting one or more settings of the media capture device 120 to improve a focus, contrast, lighting, among other parameters of the image.

In some other examples, if the application 112 is an application for submitting an image of a receipt or an image of another physical object that includes text using the media capture device 120, then example media specifications include, but are not limited to, the image including a set of configured or defined string and/or character values, a color or pattern of a background portion of the image, physical dimensions defining a size of the image, a file type of the image, or a physical dimensions defining a size of objects included in the image (e.g., the receipt) relative to the size of the image. If the image is of a receipt or other physical object that includes text, then the instructions for initializing the media capture devices 120 may include to initialize a media capture device 120 at the back of the client device 102 and adjusting one or more settings of the media capture device 120 to improve a focus, contrast, lighting, among other parameters of the image. In yet other examples, the application 112 may have any numerical quantity of functionalities for performing different computing tasks with respective capture specifications 122, including, but not limited to, gaming, media consumption (e.g., content streaming), productivity tasks (e.g., word processing, content generation, data analysis etc.), ecommerce, enterprise tasks, content generation, web browsing, communication with other devices, and so forth.

In some cases, the client device 102 may not have access to one or more specifications (e.g., the capture specifications 122) for an instance of media content when capturing the media content using the client device 102. The client device 102 may receive an indication that triggers a media content capture process for capturing an instance of media content. The client device 102 may initialize one or more media capture devices 120 for capturing the instance of media content for the application 112 and/or service provided by the application 112 according to default settings (e.g., set by a manufacturer and/or set by a user). The user may provide additional input to the client device 102 triggering the capture of the instance of the media content using the media capture devices 120. The resulting instance of the media content may not satisfy the specifications, because the user may not be aware of the specifications and the client device 102 may not have access to the specifications. Thus, the client device 102 may receive input that indicates for the client device 102 to discard the instance of the media content and that triggers capture of an additional instance of the media content to satisfy the specifications, causing increased processing and memory usage at the client device 102 related to capture of the additional instance of the media content, as well as high signaling overhead due to communications between the client device 102 and the media capture devices 120. Additionally, or alternatively, the client device 102 can implement post processing techniques to provide for modification of the instance of the media content to satisfy the specifications, causing increased usage of processing and memory resources relative to if the media content satisfied the specifications without the post processing.

To reduce usage of processing and memory resources related to an instance of media content failing to satisfy specifications, a client device 102 can aggregate capture specifications 122 for media content by inputting media specifications 116 for the media content into generative AI. For example, the client device 102 may obtain the media specifications 116 from the database 104 and/or may receive the media specifications 116 as user input. The client device 102 may input the media specifications 116 to one or more generative AI models 124. In some examples, the media specifications 116 may be obtained (e.g., by the client device 102) from criteria for the application 112, such as data that lists the criteria for the application 112. Example data includes string and/or character data, such as the instructions “Submit a high-resolution photo that is not blurry, grainy, or pixelated. The correct size of a passport photo is: 2 inches by 2 inches. Head must be between 1 and 1⅜^{th} inches from the bottom of the chin to the top of the head.” The client device 102 may utilize the generative AI models 124 to extract and aggregate capture specifications from the media specifications 116. For example, the generative AI models 124 may extract capture specifications related to “a high-resolution photo,” including specifications to satisfy a blurriness threshold, grainy threshold, and/or a pixelated threshold. Additionally, or alternatively, the generative AI models 124 may extract sizing information and/or may determine that the application 112 is collecting an image media content item for an identification document. There may be one or more capture specifications related to the sizing information and/or the use case being for an identification document (e.g., initializing a front media capture device for a user to take an image of themselves).

In some other examples, the instructions may include “The available file formats are: PDF only,” and/or “when scanning, the images should be scanned at 300 dots per inch or lower to reduce file size. For best results, scan or take a photo as a black and white picture with no more than 1024×768 image resolution.” The generative AI models 124 may extract file type information, file size information, color information, image resolution information, and more from the instructions. The generative AI models 124 may additionally, or alternatively, infer one or more capture specifications related to image scanning (e.g., initializing a rear media capture device for a user to scan an object).

Example generative AI models 124 include, but are not limited to, large language models and/or conditional generative models. A large language model is a type of artificial intelligence model designed to generate natural language. In some examples, large language models are pre-trained on a diverse text data set to learn structure, grammar, and semantics of language. A conditional generative model is an artificial intelligence model designed to generate an output using one or more input conditions or labels. The generative AI models 124 may be built using deep learning techniques and may have a greater numerical quantity of parameters than other artificial intelligence models. Unlike conventional artificial intelligence systems that rely on rule-based or deterministic approaches, generative artificial intelligence employs algorithms and models capable of autonomously producing output that closely resembles human-generated content. These algorithms are designed to learn patterns and structures from existing data and then use this learned information to generate new content that is coherent, relevant, and contextually appropriate. Although the techniques are described leveraging generative artificial intelligence, in variations, different types of artificial intelligence may be leveraged without departing from the spirit or scope of the described techniques. For example, the client device 102 may implement (e.g., use, train, and/or fine-tune) any numerical quantity of machine learning models, such as to generate a distributed network of machine learning models. The distributed network may include a prompt engineer large language model that generates prompts for other machine learning models that generate results. The machine learning models that generate the results can be trained or fine-tuned to aggregate capture specifications 122.

In some examples, a generative AI models 124 designed for generative artificial intelligence can be fine-tuned, or trained, for a specific application using data for the specific application. Fine-tuning a generative AI model 124 may include updating an existing, or pre-trained, machine learning model by training the machine learning model with a more specific dataset to adapt the machine learning model to a task or context. For example, a generative AI models 124 that has been pre-trained may be fine-tuned to aggregate capture specifications 122 by inputting training data including media specifications 116 that are labeled with capture specifications 122.

The client device 102 may determine that an application 112 and/or a service provided by the application 112 is configured to receive input of media content via one or more media capture devices 120 (e.g., one or more front and/or rear media capture devices 120 of the client device 102). The client device 102 may identify one or more media specifications 116 of the application and/or the service for the media content prior to capturing an instance of the media content. For example, the client device 102 may identify the media specifications 116 by analyzing context of the media content and/or by obtaining information including the media specifications (e.g., from a body of text provided by the application and/or user input). Analyzing the context of the media content may include identifying a use case indicative of one or more media specifications by accessing application data and/or other information. The application data may include one or more instances of media content captured from different users and/or historical captures of instances of media content. The client device 102 can use media content processing techniques to identify the media specifications 116. For example, the client device 102 can use image processing techniques (e.g., object and/or feature recognition) to detect objects and/or features of content. Additionally, or alternatively, the client device 102 can use audio processing techniques to convert an audio media content item to a text file and/or to detect one or more characteristics (e.g., volume, sample rate, file format, duration, frequency range, file size, etc.). In variations, the media content processing techniques may include inputting the application data to machine learning models (e.g., the same machine learning models as the generative AI models 124 and/or different machine learning models than the generative AI models 124) and receiving the media specifications 116 as output.

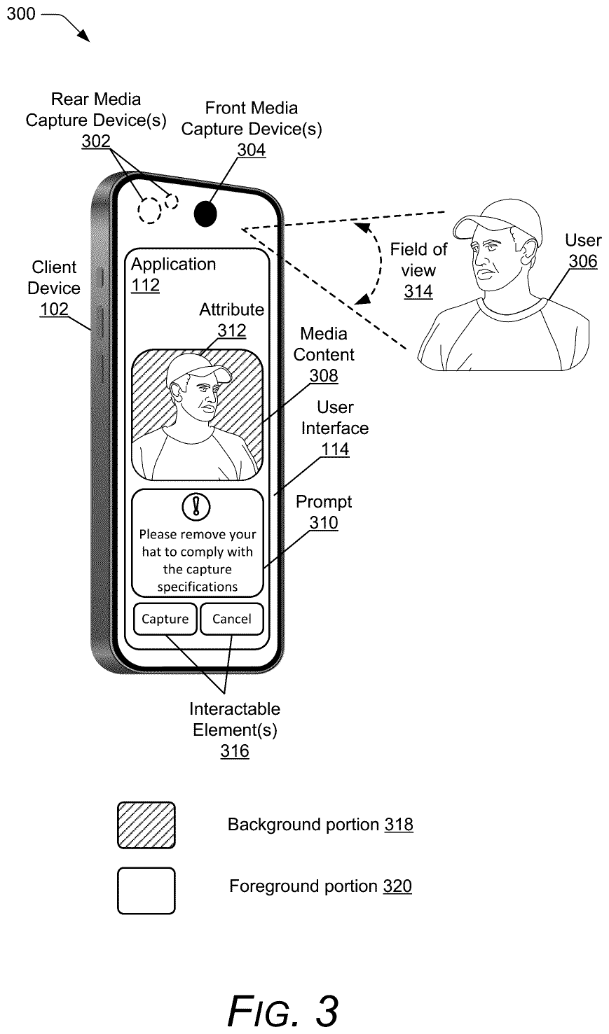

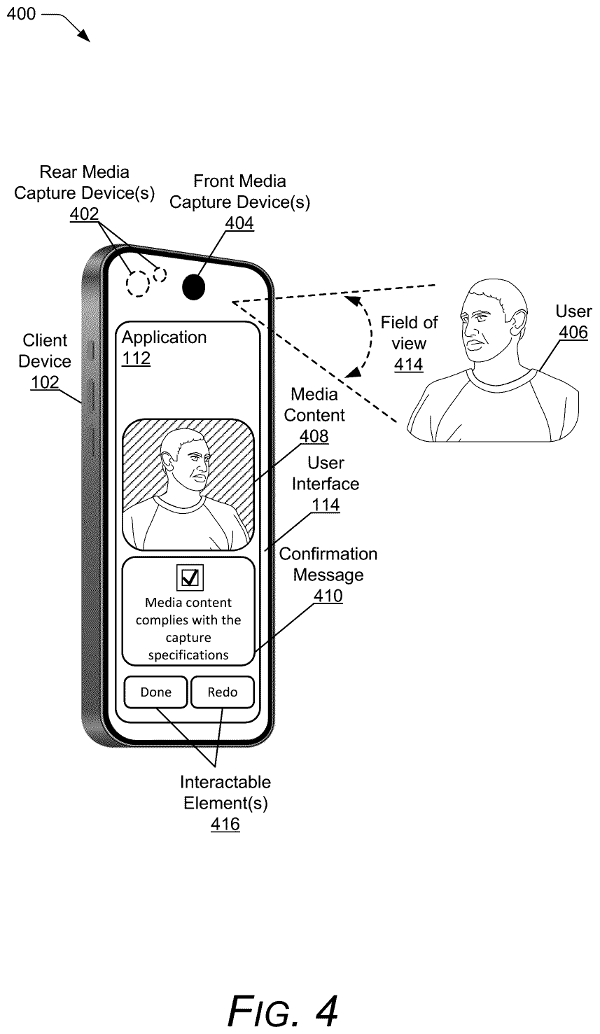

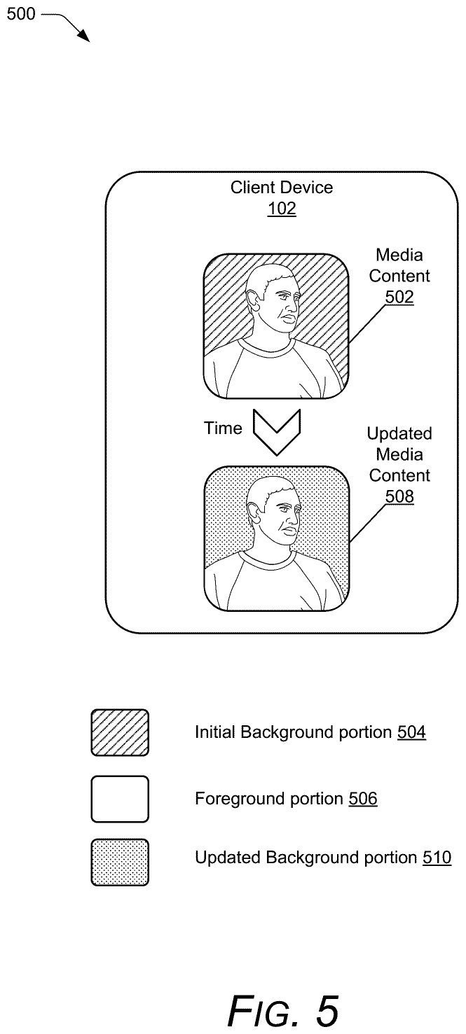

The client device 102 may input the media specifications 116 to the generative AI models 124 trained to aggregate capture specifications 122 using the media specifications 116. The client device 102 may initiate a media content capture process by launching at least one media capture device 120 according to the capture specifications 122 (e.g., front camera to capture an image of a face of a user, rear camera to capture an image of a receipt, macro camera to capture an image of a barcode or other image that is within a threshold distance from the client device 102, etc.). In some examples, the client device 102 can output prompts for display via a user interface 114 that provide user guidance for satisfying the capture specifications, which is described in further detail with respect to FIGS. 3 and 4. Once at least a portion of the capture specifications 122 are satisfied, then the client device 102 can cause an instance of the media content to be captured by a media capture device 120. Once the capture is complete and/or concurrent to capturing the instance of the media content, the client device 102 can perform additional processing on the instance of the media content to ensure the instance of the media content satisfies any remaining capture specifications 122 (e.g., replace a background portion of an image with a color defined by the capture specifications), which is described in further detail with respect to FIG. 5.

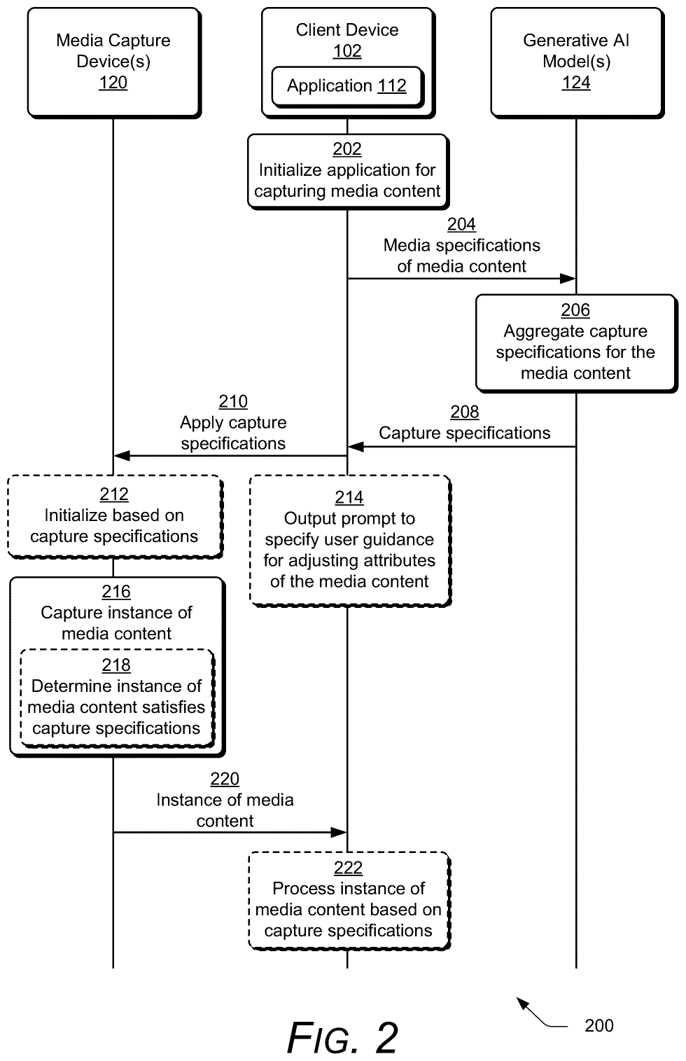

FIG. 2 illustrates an example process flow 200, which supports aggregating capture specifications for media content using generative AI in accordance with one or more implementations as described herein. The example process flow 200 may implement aspects of the example system 100. For example, the example process flow 200 can be implemented by a client device 102 implementing an application 112, one or more media capture devices 120, and one or more generative AI models 124, which may be an example of a client device 102, an application 112, media capture devices 120, and generative AI models 124 as described with reference to FIG. 1. Alternative examples of the following may be implemented, where some processes are performed in a different order than described or are not performed. In some cases, processes may include additional features not mentioned below, or further processes may be added.

At 202, a client device 102 initializes the application 112 for capturing media content. For example, the client device 102 may receive user input trigger the client device 102 to initialize the application 112. Initializing the application 112 may include updating a user interface of the client device 102 to output an instance of the application 112 for display to a user. The user interface may include a GUI.

At 204, a client device 102 inputs media specifications of media content into the generative AI models 124. For example, the client device 102 may obtain the media specifications, such as by accessing a database and/or receiving an indication of the media specifications from user input. The indication of the media specifications from user input may include an implicit indication of the media specifications and/or an explicit indication of the media specifications. For example, the user input may indicate a selected or activated portion of the user interface for capturing an instance of media content for a defined and/or configured functionality (e.g., for uploading an image, video and/or audio media component to the application 112). The selected or activated portion of the user interface may include one or more buttons and/or other interactable elements that trigger activation of a media capture device for capturing the instance of the media content. The client device 102 may analyze application data to determine the media specifications for the activated portion of the user interface and/or for the configured functionality. Additionally, or alternatively, the user may provide a text document (e.g., string and/or character values that make up the document and/or an image of a document that includes string and/or character values) to the application 112 indicating the media specifications, and the client device 102 may parse the text document to determine the media specifications.

At 206, the generative AI models aggregate capture specifications for the media content. For example, the generative AI models output aggregated capture specifications for an instance of the media content item based on the media specifications provided to the generative AI models at 204. The capture specifications can include the media specifications (e.g., file size of the instance of the media content, physical dimensions of the instance of the media content, a file format of the instance of the media content, attributes of the instance of the media content, etc.), as well as one or more instructions for initializing the media capture devices. Attributes of the instance of the media content can include, but are not limited to, objects included in the instance of the media content, audio characteristics or parameters of the instance of the media content, one or more colors or patterns included in the instance of the media content and/or one or more colors or patterns included in a portion of the instance of the media content, among others. For example, if the media content is visual media content (e.g., an image and/or a video), the media specifications can include a maximum file size, maximum or minimum media resolution, target aspect ratio, a maximum, and/or minimum bitrate, supported image and/or video compression protocol(s), among others. In an alternative, or additional, example if the media content is audio media content, then the media specifications can include specifications for audio media such as maximum file size, a specified maximum bitrate, maximum audio content duration, supported audio compression protocol(s), among others.

At 208, the generative AI models 124 output the capture specifications to the client device 102. At 210, the client device 102 applies the capture specifications at the media capture devices 120. For example, the client device 102 may apply the capture specifications by indicating for a media capture device 120 specified by the captures specifications to initialize for capturing an instance of a media content. For example, the capture specifications may indicate one or more of a macro camera, a front camera, a back camera, a front microphone, a back microphone, etc., to use for capturing the instance of the media content. The capture specifications may additionally, or alternatively, indicate one or more settings for initializing the media capture device 120 (e.g., focus settings, contrast settings, color settings, lighting settings, among other visual settings if the media content is visual media content and/or audio volume, sample rate, frequency range, among other audio settings if the media content is audio media content).

In some cases, at 212, the media capture devices 120 may initialize based on the capture specifications. For example, if the capture specifications indicate a media capture device 120 to initialize and/or settings for initializing the media capture devices 120, then the client device 102 may transmit signaling to the media capture devices 120 initializing the indicated media capture devices 120 and/or indicating the settings for initializing the media capture devices 120. The media capture devices 120 may receive the signaling and may apply the indicated settings and/or may initialize the indicated media capture device 120. Initializing the media capture devices 120 may include powering on the media capture devices 120 and applying one or more settings for capturing the instance of the media content.

At 214, the client device 102 may output a prompt to specify user guidance for adjusting attributes of the media content. The prompt may include instructions to adjust an attribute to comply or satisfy capture specifications for an instance of media content. For example, if the instance of the media content is an image of a face of a user, then the prompt may include instructions to remove an object (e.g., an article of clothing or other object) from the image to comply or satisfy the capture specifications. If the instance of the media content is an audio recording by a user, then the prompt may include instructions to increase the volume of the audio content to comply or satisfy the capture specifications. If the instance of the media content is an image of a document, then the prompt may include instructions to provide an alternate document to comply with the capture specifications, to move the document to fit within a window of the media capture device 120, or the like to comply or satisfy the capture specifications. In the examples, the object in the image, the volume of the audio content, and the document in the image are examples of attributes of the instance of the media content. The attributes can include physical characteristics and/or non-physical characteristics of the instance of the media content.

At 216, the media capture devices 120 can capture the instance of the media content. For example, the media capture devices 120 can be configured to record an audio media content, to obtain an image, or the like using one or more sensors or other components. In variations, at 218, the media capture devices 120 may determine the instance of the media content satisfies the capture specifications. For example, the media capture devices 120 may detect that one or more capture specifications are satisfied and may automatically capture the instance of the media content (e.g., independent of or without user input). Additionally, or alternatively, the client device 102 may detect that the one or more capture specifications are satisfied and may transmit signaling to the media capture devices 120 triggering the capture of the instance of the media content. In some examples, the client device 102 may determine a portion of the capture specifications that are to be satisfied prior to capture of the instance of the media content. The portion may include one or more capture specifications of the instance of the media content that cannot be satisfied by updating or modifying the instance of the media content using post processing techniques. In some other variations, the client device 102 may receive user input that overrides the automatic capture of the instance of media content. For example, the user input may trigger the capture of the instance of the media content regardless of whether the capture specifications are satisfied.

At 220, the media capture devices 120 may transmit the instance of the media content to the application 112 implemented by the client device 102. In some cases, at 222, the application 112 and/or the client device 102 may process the instance of the media content based on the capture specifications. For example, the application 112 and/or the client device 102 may perform one or more updates or modifications to the instance of the media content to satisfy the capture specifications. The updates and/or modifications can include one or more of updating or modifying a file type of the instance of the media content item, updating, or modifying a file size of the instance of the media content item, and/or updating or modifying one or more physical aspects of the instance of the media content item (e.g., changing a background portion of a visual media content item).

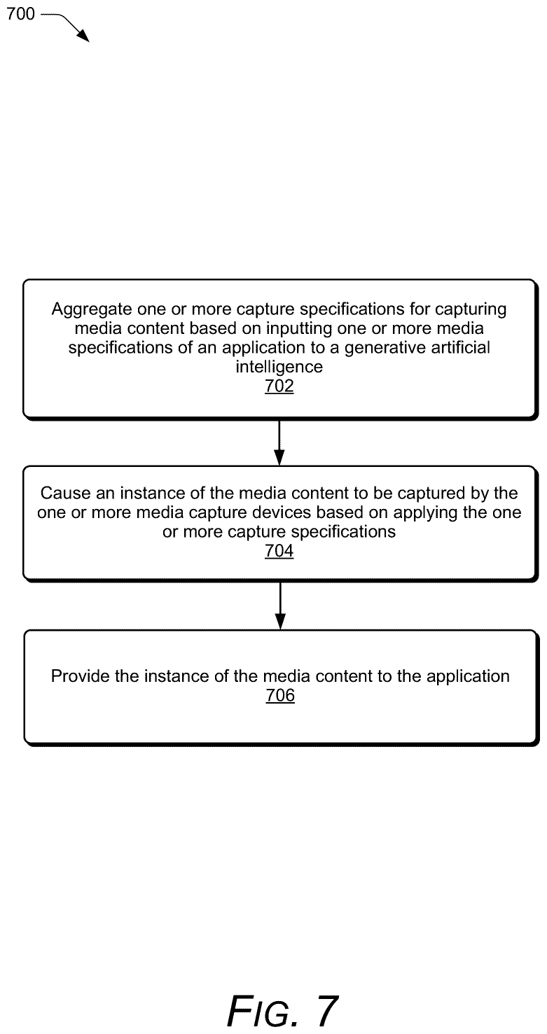

The example process flow 200, as well as example method 700, are described with reference to respective FIGS. 2 and 7 in accordance with one or more implementations of aggregating capture specifications for media content using generative AI, as described herein. Generally, any services, components, modules, managers, controllers, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

FIG. 3 illustrates an example system 300 for aggregating capture specifications for media content using generative AI in accordance with one or more implementations as described herein. The system 300 may implement aspects of the example system 100 and/or the process flow 200, as shown and described with reference to FIGS. 1 and 2. For example, the example system 300 may include a client device 102 configured to output an instance of an application 112 for display via a user interface 114, where the client device 102, the application 112, and the user interface 114 may be examples of the corresponding features as described with reference to FIGS. 1 and 2. The example system 300 may also include one or more rear media capture devices 302 and one or more front media capture devices 304, which may be examples of media capture devices 120 as described with reference to FIGS. 1 and 2.

A client device 102 can receive user input from a user 306 to initialize the application 112 for capturing an instance of media content 308. Although the media content 308 is illustrated as an image (e.g., an image of a user 306), the media content 308 may be any type of media content, including video media content and/or audio media content. Similarly, the rear media capture devices 302 and/or the front media capture devices 304 may be any type of media capture devices, including cameras and/or microphones.

In some cases, the client device 102 may aggregate one or more capture specifications for capturing the media content 308. For example, the client device 102 may input media specifications of the application 112 to generative AI models, as described with reference to FIGS. 1 and 2. The client device 102 may apply the capture specifications by initializing the rear media capture devices 302 and/or the front media capture devices 304 according to the capture specifications. For example, the client device 102 may initialize a front media capture device 304 that supports a relatively close range (e.g., capturing media content 308 for an object and/or user 306 that is within a threshold distance from the client device 102 and/or within a threshold distance from the front media capture device 304) for capturing an image of a face of a user 306. The capture specifications may indicate for the client device 102 to initialize the front media capture device 304.

Additionally, or alternatively, the client device 102 may apply the capture specifications by outputting a prompt 310 for display to the user 306 via the user interface 114. In some cases, the client device 102 may detect that one or more attributes 312 of the media content 308 fail to satisfy the captures specifications. The client device 102 may generate the prompt 310 that includes user guidance for updating the one or more attributes 312 of the media content 308 to satisfy the capture specifications. For example, the client device 102 may determine one or more objects in the media content 308 (e.g., one or more attributes of the media content 308) are to be removed from the media content 308 to satisfy the capture specifications. The objects may include an article of clothing worn by the user 306, such as a hat. The prompt 310 may include feedback in the form of text and/or audio media to be presented to the user 306. The client device 102 can output the prompt 310 for display via a user interface 114 to indicate for the user 306 to update or modify the media content 308. For example, the prompt 310 may include a text prompt with the content “Please remove your hat to comply with the capture specifications.” Although the attribute 312 described and illustrated in the system 300 is a physical attribute, the attribute 312 may be any characteristic (e.g., physical, or non-physical characteristic) of the media content 308.

In some examples, the rear media capture devices 302 and/or the front media capture devices 304 may have a field of view 314. The field of view 314 may be directed in an orientation relative to the client device 102 and/or the user 306. The prompt 310 may include instructions for placement of an object (e.g., a document, a face of the user 306, etc.) within the field of view 314 of the rear media capture devices 302 and/or the front media capture devices 304. Additionally, or alternatively, the capture specifications may include an orientation (e.g., direction) for initializing a media capture device to capture a field of view 314. The field of view 314 may be different for different media capture devices. For example, a macro camera may have a different field of view 314 than a non-macro camera.

In some cases, the user interface 114 displaying the instance of the application 112 may include one or more interactable elements 316, including, but not limited to, buttons, drop-down menus, or text input options, among other features or elements. For example, the user interface 114 may include an interactable element 316 selectable by the user 306 to capture the instance of the media content 308, labeled “Capture” and/or an interactable element 316 selectable by the user 306 to cancel the capture of the instance of the media content 308, labeled “Cancel.” If the client device 102 receives user input indicating a selection of the interactable element 316 to capture the instance of the media content 308, then the client device 102 may trigger a media capture device to capture the instance of the media content 308 (e.g., regardless of whether the capture specifications are satisfied). If the client device 102 receives user input indicating a selection of the interactable element 316 to cancel the instance of the media content 308, then the client device 102 may trigger display of a user interface 114 of another instance of the application 112 (e.g., not related to capture of the media content 308 and/or related to capture of different media content 308, among other user interfaces 114).

In some cases, the media content 308 can be divided or separated into different portions. For example, if the media content 308 is visual media content, then the media content 308 may be separated into a background portion 318 and a foreground portion 320. The client device 102 may use image processing techniques (e.g., thresholding, color-based segmentation, edge detection, machine learning based segmentation, among other image processing techniques) to separate visual media content into the background portion 318 and the foreground portion 320. In some examples, the capture specifications include criteria related to the background portion 318 and/or the foreground portion 320, which is described in further detail with respect to FIG. 5.

FIG. 4 illustrates an example system 400 for aggregating capture specifications for media content using generative AI in accordance with one or more implementations as described herein. The system 400 may implement aspects of the example system 100, the process flow 200, and/or the example system 300, as shown and described with reference to FIGS. 1 through 3. For example, the example system 400 may include a client device 102 configured to output an instance of an application 112 for display via a user interface 114, where the client device 102, the application 112, and the user interface 114 may be examples of the corresponding features as described with reference to FIGS. 1 through 3. The example system 400 may also include one or more rear media capture devices 402 and one or more front media capture devices 404, which may be examples of media capture devices 120 as described with reference to FIGS. 1 and 2.

A client device 102 can receive user input from a user 406 to initialize the application 112 for capturing an instance of media content 408. Although the media content 408 is illustrated as an image (e.g., an image of a user 406), the media content 408 may be any type of media content, including video media content and/or audio media content. Similarly, the rear media capture devices 402 and/or the front media capture devices 404 may be any type of media capture devices, including cameras and/or microphones.

In some cases, the client device 102 may aggregate one or more capture specifications for capturing the media content 408. For example, the client device 102 may input media specifications of the application 112 to generative AI models, as described with reference to FIGS. 1 and 2. The client device 102 may apply the capture specifications by initializing the rear media capture devices 402 and/or the front media capture devices 404 according to the capture specifications. For example, the client device 102 may initialize a front media capture device 404 that supports a relatively close range (e.g., capturing media content 408 for an object and/or user 406 that is within a threshold distance from the client device 102 and/or within a threshold distance from the front media capture device 404) for capturing an image of a face of a user 406. The capture specifications may indicate for the client device 102 to initialize the front media capture device 404.

Additionally, or alternatively, the client device 102 may apply the capture specifications by outputting one or more prompts for display to the user 406 via the user interface 114, as described with reference to FIG. 3. In some cases, the client device 102 may detect that the media content 408 satisfies at least a portion of the capture specifications. In some examples, the client device 102 may determine the portion of the capture specifications that are to be satisfied prior to capture of the instance of the media content 408. The portion may include one or more capture specifications of the instance of the media content 408 that cannot be satisfied by updating or modifying the instance of the media content 408 using post processing techniques. In some examples, the client device 102 instructs the rear media capture devices 402 and/or the front media capture devices 404 to capture the instance of the media content 408 once the portion and/or the entirety of the capture specifications are satisfied. Thus, the instance of the media content 408 is captured independent of, or without, user input.

The client device 102 may generate a confirmation message 410 for output via the user interface 114. The confirmation message 410 may include text data for display. For example, the confirmation message 410 may include the text “Media content complies with the capture specifications,” or any other text that indicates that the media content 408 satisfies the capture specifications and/or that the instance of the media content 408 is captured. In some examples, the rear media capture devices 402 and/or the front media capture devices 404 may have a field of view 414. The client device 102 may trigger capture of the instance of the media content 408 within the field of view 414 of the rear media capture devices 402 and/or the front media capture devices 404. The field of view 314 may be different for different media capture devices. For example, a macro camera may have a different field of view 314 than a non-macro camera.

In some cases, the user interface 114 displaying the instance of the application 112 may include one or more interactable elements 416, including, but not limited to, buttons, drop-down menus, or text input options, among other features or elements. For example, the user interface 114 may include an interactable element 416 selectable by the user 406 to initiate an additional a capture of the instance of the media content 408, labeled “Redo” and/or an interactable element 416 selectable by the user 406 to approve the instance of the media content 408, labeled “Done.” If the client device 102 receives user input indicating a selection of the interactable element 416 to initiate an additional capture of the instance of the media content 408, then the client device 102 may perform another media capture process. If the client device 102 receives user input indicating a selection of the interactable element 416 to approve the instance of the media content 408, then the client device 102 may trigger display of a user interface 114 of another instance of the application 112 (e.g., not related to capture of the media content 408 and/or related to capture of different media content 408, among other user interfaces 114).

FIG. 5 illustrates an example processing diagram 500 for aggregating capture specifications for media content using generative AI in accordance with one or more implementations as described herein. The example processing diagram 500 may implement aspects of the example system 100, the process flow 200, the example system 300, and/or the example system 400, as shown and described with reference to FIGS. 1 through 4. For example, the example processing diagram 500 may be implemented by a client device 102 configured to output an instance of an application, where the client device 102 may be examples of the corresponding features as described with reference to FIGS. 1 through 4.

In some examples, a client device 102 may capture an instance of media content 502 using one or more media capture devices and/or may trigger capture of an instance of media content 502 by one or more media capture devices. The client device 102 may send the instance of the media content 502 to an application for processing and/or post processing. Additionally, or alternatively, the client device 102 may perform the processing and/or post processing. The client device 102 may determine whether the media content 502 satisfies one or more capture specifications related to attributes, features, aspects, and/or characteristics of the media content 502 that may be modified and/or updated after capture of the instance of the media content 502. For example, the client device 102 may determine whether a file size of the media content 502 satisfies a threshold file size indicated by the capture specifications, whether a file type of the media content 502 satisfies a file type indicated by the capture specifications, whether a background portion of the media content 502 and/or a foreground portion of the media content 502 satisfies a color and/or pattern criteria indicated by the capture specifications, among other aspects of the media content 502 related to the capture specifications.

In some cases, the media content 502 can be divided or separated into different portions by the client device 102 for analysis. For example, if the media content 502 is visual media content, then the media content 502 may be separated into an initial background portion 504 and a foreground portion 506. The client device 102 may use image processing techniques (e.g., thresholding, color-based segmentation, edge detection, machine learning based segmentation, among other image processing techniques) to separate visual media content into the initial background portion 504 and the foreground portion 506.

In some examples, the capture specifications include criteria related to a background portion and/or a foreground portion 506 of an instance of the media content 502. For example, the capture specifications may specify a color criteria for the background portion and/or a foreground portion 506 of the instance of the media content 502. Additionally, or alternatively, the capture specifications may specify a pattern criteria for the background portion and/or a foreground portion 506 of the instance of the media content 502. In some examples, the capture specifications may specify for the instance of the media content 502 to have no background portion. The client device 102 may update or modify the media content 502 according to the capture specifications. For example, the client device 102 may modify the media content 502 to produce the updated media content 508. The updated media content 508 may include an updated background portion 510, which may include updating a color of the initial background portion 504, updating a pattern of the initial background portion 504, removing the initial background portion 504, or any other change or modification to the initial background portion 504 of the media content 502.

Although the processing diagram 500 illustrates modification to a background of the media content 502, the processing techniques may include any modifications to the media content 502 after the instance of the media content 502 is captured. Further, the processing of the media content 502 may occur prior to the capture of the instance of the media content 502. For example, the client device 102 may modify the media content 502 in real time, or near-real time, as the instance of the media content 502 is captured.

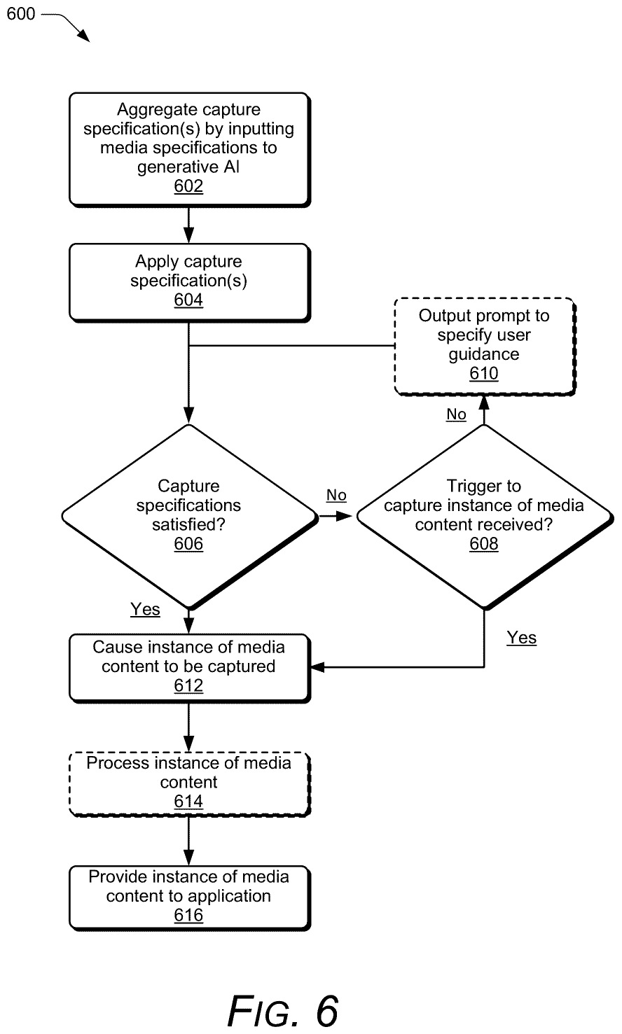

FIG. 6 illustrates an example block diagram 600 for aggregating capture specifications for media content using generative AI in accordance with one or more implementations as described herein. The block diagram 600 may implement aspects of the example system 100, as well as any of the example process flow 200, the example system 300, the example system 400, or the processing diagram 500. For example, the example block diagram 600 can be implemented by a client device 102, which may be an example of the client device 102 as described with reference to FIGS. 1 through 5.

At 602, capture specifications are aggregated by inputting media specifications to generative AI. In some cases, a client device 102 may obtain media specifications of an application (e.g., from a database 104 as described with reference to FIG. 1 and/or from user input). For example, the client device 102 may receive an implicit indication of the media specification and/or an explicit indication of the media specification. The indication may be provided by user input from a user interface. In some cases, the user input specifies a context of the media content and/or string data or character data indicating the media specifications. In some other examples, the client device 102 may access a database storing information (e.g., application data) indicating the media specifications. The client device 102 may input the media specifications to one or more generative AI Models. The generative AI models provide the aggregated capture specifications as output.

At 604, the capture specifications are applied. In some examples, to apply the capture specifications, a client device 102 initiates media capture devices according to the one or more capture specifications. The capture specifications may include an orientation (e.g., direction of a field of view) of the one or more media capture devices.

At 606, a determination is made as to whether the capture specifications are satisfied. At 608, a determination is made as to whether a trigger is received to capture an instance of media content. If the capture specifications are not satisfied, and if the trigger is not received to capture the instance of the media content, then the client device 102 may output a prompt to specify user guidance for adjusting one or more attributes of the media content to satisfy the capture specifications. In some cases, at 610, a prompt is output to specify the user guidance. The prompt may include one or more of a text output for display at a user interface of the client device 102, an audio output from an audio component of the client device 102, or an image output for display at the user interface of the client device 102. Adjusting the one or more attributes of the media content may include removing an object from the media content to satisfy the one or more capture specifications.

At 612, an instance of the media content is caused to be captured. For example, if the capture specifications are satisfied, and/or if the trigger is received to capture the instance of the media content, then the client device 102 may cause an instance of media content to be captured by one or more media capture devices. The trigger to capture the instance of the media content may bet received as user input via a user interface of the client device 102. The one or more media capture devices may include one or more of a front image capture system or a rear image capture system. The one or more capture specifications may include an indication of one or more of the front image capture system or the rear image capture system to use for causing the instance of the media content to be captured.

In some cases, at 614, the instance of the media content is processed. For example, the instance of the media content is processed to satisfy one or more capture specifications. The processing may include the client device 102 detecting a first portion of the instance of the media content representative of an object and/or user to be captured, referred to as a foreground portion of the instance of the media content, and a second portion of the instance of the media content representative of a background of the object and/or user, referred to as a background portion of the instance of the media content. The client device 102 may modify a color associated with the second portion of the instance of the media content according to the capture specifications (e.g., to satisfy the capture specifications). The capture specifications may include a color associated with the instance of the media content, a threshold file size associated with the instance of the media content, one or more threshold dimensions of the instance of the media content, or a format or type associated with the instance of the media content.

At 616, the instance of the media content is provided to the application. The application may use the media content according to the functionality of the application. For example, if the application has a social media functionality, then the application may upload the instance of the media content for display via a user account. In some other examples, if the application has an identification document generation functionality, then the application may upload the instance of the media content for inclusion in the identification document. Although the media content is described in various examples as being visual media content (e.g., an image and/or a video), the media content may be any type of digital media.

FIG. 7 illustrates one or more example methods 700 for aggregating capture specifications for media content using generative AI. The order in which the method is described is not intended to be construed as a limitation, and any number or combination of the described method operations can be performed in any order to perform a method, or an alternate method.

At 702, one or more capture specifications for capturing media content are aggregated based on inputting one or more media specifications of an application to a generative AI. In some cases, user input is received via the client device 102 that indicates the one or more media specifications. The user input may be associated with a context corresponding to the media content, where the user input includes one or more of string data or character data. To aggregate the one or more capture specifications, the one or more capture specifications are received as output from the generative AI.

At 704, an instance of the media content is caused to be captured by the one or more media capture devices based on applying the one or more capture specifications. In some cases, to apply the one or more capture specifications, the media capture devices are initiated or initialized according to the one or more capture specifications. The one or more capture specifications may include an orientation of the one or more media capture devices.

In some other cases, to apply the one or more capture specifications, a prompt is output via the client device 102 to specify user guidance for adjusting one or more attributes of the media content based on the one or more capture specifications. The prompt may include one or more of a text output for display at a user interface of the client device 102, an audio output from an audio component of the client device 102, or an image output for display at the user interface of the client device 102. Adjusting the one or more attributes of the media content may include removing an object from the media content to satisfy the one or more capture specifications.

In some examples, the instance of the media content is processed based on the one or more capture specifications. For example, a first portion of the instance of the media content associated with an object and a second portion of the instance of the media content associated with a background of the object are detected. A color associated with the second portion of the instance of the media content is modified based on the one or more capture specifications. The one or more capture specifications may include a color associated with the instance of the media content, a threshold file size associated with the instance of the media content, one or more threshold dimensions of the instance of the media content, or a format associated with the instance of the media content.

In some cases, to cause the instance of the media content to be captured by the one or more media capture devices of the client device 102, the client device 102 determines to capture the instance of the media content based on the instance of the media content satisfying the one or more capture specifications. Additionally, or alternatively, user input is received that triggers capture of the instance of the media content. In some cases, the one or more media capture devices include one or more of a front image capture system or a rear image capture system, where the one or more capture specifications includes an indication of one or more of the front image capture system or the rear image capture system to use for causing the instance of the media content to be captured.

At 706, the instance of the media content is provided to the application. In variations, Further, the application can request specific media content to be included in media content to be input to the application. The application may use the instance of the media content as media input (e.g., without additional processing to the instance of the media content).

FIG. 8 illustrates various components of an example device 800, which can implement aspects of the techniques and features for aggregating capture specifications for media content using generative AI, as described herein. The example device 800 can be implemented as any of the devices described with reference to the previous FIGS. 1 through 7, such as any type of a wireless device, mobile device (e.g., the client device 102), mobile phone, flip phone, client device, companion device, paired device, display device, tablet, computing, communication, entertainment, gaming, media playback, and/or any other type of computing, consumer, and/or electronic device. For example, the client device 102 described with reference to FIGS. 1 through 7 may be implemented as the example device 800.

The example device 800 can include various, different communication devices 802 that enable wired and/or wireless communication of device data 804 with other devices. The device data 804 can include any of the various device's data and content that is generated, processed, determined, received, stored, and/or communicated from one computing device to another. Generally, the device data 804 can include any form of audio, video, image, graphics, and/or electronic data that is generated by applications executing on a device. The communication devices 802 can also include transceivers for cellular phone communication and/or for any type of network data communication.

The example device 800 can also include various, different types of data input/output (I/O) interfaces 806, such as data network interfaces that provide connection and/or communication links between the devices, data networks, and other devices. The I/O interfaces 806 can be used to couple the device to any type of components, peripherals, and/or accessory devices, such as a computer input device that may be integrated with the example device 800. The I/O interfaces 806 may also include data input ports via which any type of data, information, media content, communications, messages, and/or inputs can be received, such as user inputs to the device, as well as any type of audio, video, image, graphics, and/or electronic data received from any content and/or data source.

The example device 800 includes a processor system 808 of one or more processors (e.g., any of microprocessors, controllers, and the like) and/or a processor and memory system implemented as a system-on-chip (SoC) that processes computer-executable instructions. The processor system 808 may be implemented at least partially in computer hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively, or in addition, the device can be implemented with any one or combination of software, hardware, firmware, or fixed logic circuitry that may be implemented in connection with processing and control circuits, which are generally identified at 810. The example device 800 may also include any type of a system bus or other data and command transfer system that couples the various components within the device. A system bus can include any one or combination of different bus structures and architectures, as well as control and data lines.

The example device 800 also includes memory and/or memory devices 812 (e.g., computer-readable storage memory) that enable data storage, such as data storage devices implemented in hardware which can be accessed by a computing device, and that provide persistent storage of data and executable instructions (e.g., software applications, programs, functions, and the like). Examples of the memory devices 812 include volatile memory and non-volatile memory, fixed and removable media devices, and any suitable memory device or electronic data storage that maintains data for computing device access. The memory devices 812 can include various implementations of random-access memory (RAM), read-only memory (ROM), flash memory, and other types of storage media in various memory device configurations. The example device 800 may also include a mass storage media device.

The memory devices 812 (e.g., as computer-readable storage memory) provide data storage mechanisms, such as to store the device data 804, other types of information and/or electronic data, and various device applications 814 (e.g., software applications and/or modules). For example, an operating system 816 can be maintained as software instructions with a memory device 812 and executed by the processor system 808 as a software application. The device applications 814 may also include a device manager, such as any form of a control application, software application, signal-processing and control module, code that is specific to a particular device, a hardware abstraction layer for a particular device, and so on.

In this example, the device 800 includes a media capture system 818 that implements various aspects of the described features and techniques described herein. The media capture system 818 can be implemented with hardware components and/or in software as one of the device applications 814, such as when the example device 800 is implemented as the client device 102 described with reference to FIGS. 1 through 6. An example of the media capture system 818 is the media capture system 110 implemented in the client device 102, such as a software application and/or as hardware components in the wireless device. In implementations, the media capture system 818 may include independent processing, memory, and logic components as a computing and/or electronic device integrated with the example device 800.

The example device 800 can also include a microphone 820 and/or camera devices 822, as well as proximity and/or motion sensors 824, such as may be implemented as components of an inertial measurement unit (IMU). The proximity and/or motion sensors 824 can be implemented with various sensors, such as a gyroscope, an accelerometer, and/or other types of motion sensors to sense motion of the device. The motion sensors 824 can generate sensor data vectors having three-dimensional parameters (e.g., rotational vectors in x, y, and z-axis coordinates) indicating location, position, acceleration, rotational speed, and/or orientation of the device. The example device 800 can also include one or more power sources 826, such as when the device is implemented as a wireless device and/or a client device 102. The power sources may include a charging and/or power system, and can be implemented as a flexible strip battery, a rechargeable battery, a charged super-capacitor, and/or any other type of active or passive power source.

The example device 800 can also include an audio and/or video processing system 828 that generates audio data for an audio system 830 and/or generates display data for a display system 832. The audio system and/or the display system may include any types of devices or modules that generate, process, display, and/or otherwise render audio, video, display, and/or image data. Display data and audio signals can be communicated to an audio component and/or to a display component via any type of audio and/or video connection or data link. In implementations, the audio system and/or the display system are integrated components of the example device 800. Alternatively, the audio system and/or the display system are external, peripheral components to the example device.

In some aspects, the techniques described herein relate to a client device including one or more processors, one or more media capture devices, and one or more memory configured to cause the one or more processors to aggregate one or more capture specifications for capturing media content based on inputting one or more media specifications of an application to a generative artificial intelligence, cause an instance of the media content to be captured by the one or more media capture devices based on applying the one or more capture specifications, and provide the instance of the media content to the application.

In some aspects, the techniques described herein relate to a client device, where, to apply the one or more capture specifications, the one or more processors are further configured to initialize the one or more media capture devices according to the one or more capture specifications, and where the one or more capture specifications include an orientation of the one or more media capture devices.

In some aspects, the techniques described herein relate to a client device, where to apply the one or more capture specifications, the one or more processors are further configured to output, via the client device, a prompt to specify user guidance for adjusting one or more attributes of the media content based on the one or more capture specifications, and where the prompt includes one or more of a text output for display at a user interface of the client device, an audio output from an audio component of the client device, or an image output for display at the user interface of the client device.

In some aspects, the techniques described herein relate to a client device, where adjusting the one or more attributes of the media content includes removing an object from the media content to satisfy the one or more capture specifications.

In some aspects, the techniques described herein relate to a client device, where the one or more processors are further configured to process the instance of the media content based on the one or more capture specifications.

In some aspects, the techniques described herein relate to a client device, where to process the instance of the media content, the one or more processors are further configured to detect a first portion of the instance of the media content associated with an object and a second portion of the instance of the media content associated with a background of the object, and modify a color associated with the second portion of the instance of the media content based on the one or more capture specifications.

In some aspects, the techniques described herein relate to a client device, where the one or more capture specifications include a color associated with the instance of the media content, a threshold file size associated with the instance of the media content, one or more threshold dimensions of the instance of the media content, or a format associated with the instance of the media content.

In some aspects, the techniques described herein relate to a client device, where to cause the instance of the media content to be captured by the one or more media capture devices of the client device, the one or more processors are further configured to determine to capture the instance of the media content based on the instance of the media content satisfying the one or more capture specifications.

In some aspects, the techniques described herein relate to a client device, where to cause the instance of the media content to be captured by the one or more media capture devices of the client device, the one or more processors are further configured to receive user input triggering capture of the instance of the media content.

In some aspects, the techniques described herein relate to a client device, where the one or more processors are further configured to receive, via the client device, user input indicating the one or more media specifications.

In some aspects, the techniques described herein relate to a client device, where the user input is associated with a context corresponding to the media content, and where the user input includes one or more of string data or character data.

In some aspects, the techniques described herein relate to a client device, where, to aggregate the one or more capture specifications, the one or more processors are further configured to receive, as output from the generative artificial intelligence, the one or more capture specifications.

In some aspects, the techniques described herein relate to a client device, where the one or more media capture devices include one or more of a front image capture system or a rear image capture system, and where the one or more capture specifications includes an indication of one or more of the front image capture system or the rear image capture system to use for causing the instance of the media content to be captured.

In some aspects, the techniques described herein relate to a method including aggregating one or more capture specifications for capturing media content based on inputting one or more media specifications of an application to a generative artificial intelligence, causing an instance of the media content to be captured by one or more media capture devices of a client device based on applying the one or more capture specifications, and providing the instance of the media content to the application.

In some aspects, the techniques described herein relate to a method, where applying the one or more capture specifications includes initializing the one or more media capture devices according to the one or more capture specifications, and where the one or more capture specifications include an orientation of the one or more media capture devices.

In some aspects, the techniques described herein relate to a method, where applying the one or more capture specifications includes outputting, via the client device, a prompt to specify user guidance for adjusting one or more attributes of the media content based on the one or more capture specifications, and where the prompt includes one or more of a text output for display at a user interface of the client device, an audio output from an audio component of the client device, or an image output for display at the user interface of the client device.

In some aspects, the techniques described herein relate to a method, where causing the instance of the media content to be captured by the one or more media capture devices of the client device further includes determining, by the client device, to capture the instance of the media content based on the instance of the media content satisfying the one or more capture specifications.

In some aspects, the techniques described herein relate to a system including one or more processors, and computer-readable storage media storing instructions that are executable by the one or more processors to aggregate one or more capture specifications for capturing media content based on inputting one or more media specifications of an application to a generative artificial intelligence, cause an instance of the media content to be obtained by one or more media capture devices based on applying the one or more capture specifications, and provide the instance of the media content to the application.

In some aspects, the techniques described herein relate to a system, where, to apply the one or more capture specifications, the instructions are further executable by the one or more processors to initialize the one or more media capture devices according to the one or more capture specifications, and where the one or more capture specifications include an orientation of the one or more media capture devices.

In some aspects, the techniques described herein relate to a system, where to apply the one or more capture specifications, the instructions are further executable by the one or more processors to output a prompt to specify user guidance for adjusting one or more attributes of the media content based on the one or more capture specifications, and where the prompt includes one or more of a text output for display at a user interface of a client device, an audio output from an audio component of the client device, or an image output for display at the user interface of the client device.

1. A client device comprising:
one or more processors;
one or more media capture devices; and
one or more memory configured to cause the one or more processors to:
aggregate one or more capture specifications for capturing media content based on inputting one or more media specifications of an application to a generative artificial intelligence;
cause an instance of the media content to be captured by the one or more media capture devices based on applying the one or more capture specifications; and
provide the instance of the media content to the application.

2. The client device of claim 1, wherein, to apply the one or more capture specifications, the one or more processors are further configured to initialize the one or more media capture devices according to the one or more capture specifications, and wherein the one or more capture specifications include an orientation of the one or more media capture devices.

3. The client device of claim 1, wherein to apply the one or more capture specifications, the one or more processors are further configured to output, via the client device, a prompt to specify user guidance for adjusting one or more attributes of the media content based on the one or more capture specifications, and wherein the prompt includes one or more of a text output for display at a user interface of the client device, an audio output from an audio component of the client device, or an image output for display at the user interface of the client device.

4. The client device of claim 3, wherein adjusting the one or more attributes of the media content includes removing an object from the media content to satisfy the one or more capture specifications.

5. The client device of claim 1, wherein the one or more processors are further configured to process the instance of the media content based on the one or more capture specifications.

6. The client device of claim 5, wherein to process the instance of the media content, the one or more processors are further configured to:
detect a first portion of the instance of the media content associated with an object and a second portion of the instance of the media content associated with a background of the object; and
modify a color associated with the second portion of the instance of the media content based on the one or more capture specifications.

7. The client device of claim 5, wherein the one or more capture specifications include a color associated with the instance of the media content, a threshold file size associated with the instance of the media content, one or more threshold dimensions of the instance of the media content, or a format associated with the instance of the media content.

8. The client device of claim 1, wherein to cause the instance of the media content to be captured by the one or more media capture devices of the client device, the one or more processors are further configured to determine to capture the instance of the media content based on the instance of the media content satisfying the one or more capture specifications.

9. The client device of claim 1, wherein to cause the instance of the media content to be captured by the one or more media capture devices of the client device, the one or more processors are further configured to receive user input triggering capture of the instance of the media content.

10. The client device of claim 1, wherein the one or more processors are further configured to receive, via the client device, user input indicating the one or more media specifications.

11. The client device of claim 10, wherein the user input is associated with a context corresponding to the media content, and wherein the user input includes one or more of string data or character data.

12. The client device of claim 1, wherein, to aggregate the one or more capture specifications, the one or more processors are further configured to receive, as output from the generative artificial intelligence, the one or more capture specifications.

13. The client device of claim 1, wherein the one or more media capture devices include one or more of a front image capture system or a rear image capture system, and wherein the one or more capture specifications includes an indication of one or more of the front image capture system or the rear image capture system to use for causing the instance of the media content to be captured.

14. A method comprising:
aggregating one or more capture specifications for capturing media content based on inputting one or more media specifications of an application to a generative artificial intelligence;
causing an instance of the media content to be captured by one or more media capture devices of a client device based on applying the one or more capture specifications; and
providing the instance of the media content to the application.

15. The method of claim 14, wherein applying the one or more capture specifications comprises initializing the one or more media capture devices according to the one or more capture specifications, and wherein the one or more capture specifications include an orientation of the one or more media capture devices.

16. The method of claim 14, wherein applying the one or more capture specifications comprises outputting, via the client device, a prompt to specify user guidance for adjusting one or more attributes of the media content based on the one or more capture specifications, and wherein the prompt includes one or more of a text output for display at a user interface of the client device, an audio output from an audio component of the client device, or an image output for display at the user interface of the client device.

17. The method of claim 14, wherein causing the instance of the media content to be captured by the one or more media capture devices of the client device further comprises determining, by the client device, to capture the instance of the media content based on the instance of the media content satisfying the one or more capture specifications.

18. A system comprising:
one or more processors; and
computer-readable storage media storing instructions that are executable by the one or more processors to:
aggregate one or more capture specifications for capturing media content based on inputting one or more media specifications of an application to a generative artificial intelligence;
cause an instance of the media content to be obtained by one or more media capture devices based on applying the one or more capture specifications; and
provide the instance of the media content to the application.

19. The system of claim 18, wherein, to apply the one or more capture specifications, the instructions are further executable by the one or more processors to initialize the one or more media capture devices according to the one or more capture specifications, and wherein the one or more capture specifications include an orientation of the one or more media capture devices.

20. The system of claim 18, wherein to apply the one or more capture specifications, the instructions are further executable by the one or more processors to output a prompt to specify user guidance for adjusting one or more attributes of the media content based on the one or more capture specifications, and wherein the prompt includes one or more of a text output for display at a user interface of a client device, an audio output from an audio component of the client device, or an image output for display at the user interface of the client device.
